(19) United States
(12) Patent Application Publication
(10) Pub. No.: US 2013/0063371 A1
(43) Pub. Date: Mar. 14, 2013

(54) TOUCH PANEL

(71) Applicants: Woo Jin Lee, Seoul (KR); Jae Hun Kim, Seoul (KR); Chung Mo Yang, Gyunggi-do (KR); In Hyung Lee, Gyunggi-do (KR); Sang Su Hong, Gyunggi-do (KR); Young Woo Lee, Gyunggi-do (KR)

(72) Inventors: Woo Jin Lee, Seoul (KR); Jae Hun Kim, Seoul (KR); Chung Mo Yang, Gyunggi-do (KR); In Hyung Lee, Gyunggi-do (KR); Sang Su Hong, Gyunggi-do (KR); Young Woo Lee, Gyunggi-do (KR)

(73) Assignee: SAMSUNG ELECTRO-MECHANICS CO., LTD., Gyunggi-do (KR)

(21) Appl. No.: 13/312,545

(22) Filed: Dec. 6, 2011

(30) Foreign Application Priority Data
Sep. 8, 2011 (KR) 1020110091155

(51) Int. Cl. G06F 3/041

(52) U.S. Cl. 345/173

(57) ABSTRACT

Disclosed herein is a structure of a touch panel capable of solving a depletion problem of resources used for a transparent conductive layer, in particular, improving a moiré phenomenon occurring during a image projection process when a metal electrode in a mesh shape is formed on both surfaces of the transparent substrate, by replacing ITO and forming electrodes using a metal thin film on which fine patterns are formed. Exemplary embodiments of the present invention can improve the moiré phenomenon occurring due to overlapping lines between the top and bottom metal electrodes on the transparent substrate during the image projection process and can improve the visibility by minimizing overlapping lines between the metal electrode formed on the transparent substrate and the pixel grid or the black matrix formed on the color filter.

### CROSS REFERENCE TO RELATED APPLICATION

This application claims the benefit of Korean Patent Application No. 10-2011-0091155, filed on Sep. 8, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

As a computer using a digital technology is developed, accessory devices of the computer have also been developed. A personal computer, a portable transmission device, and other personal only information processing devices, or the like, perform text and graphic processing using various input devices such as a keyboard, a mouse, or the like.

However, as an information-oriented society is rapidly progressed, a usage of the computer has gradually expanded. It is difficult to efficiently drive products only by the keyboard and the mouse serving as the present input devices. Therefore, a need for devices that is simple and has little malfunction while allowing anyone to easily input information is increased.

In addition, a technology for an input device has been evolved to a technology of high reliability, durability, innovation, design and machining, or the like, including a technology of satisfying general functions. In order to achieve the above objects, a touch panel as an input device capable of inputting information such as text, graphic, or the like, has been developed.

The touch panel is installed on a display surface of a flat panel display, such as an electronic notebook, a liquid crystal display device (LCD), a plasma display panel (PDF), electroluminescence (El), or the like, and an image display device, such as a cathode ray tube (CRT), which is a tool used for a user to select desired information while watching an image display device.

Meanwhile, a demand for a transparent conductive layer material has also increased with a sudden expansion of a thin display field business, centering around an LCD. As the transparent conductive layer material, indium tin oxide (ITO) has been mainly used. When considering the rising demand for applications due to excellent characteristics of the ITO as a transparent electrode, it is expected that the consumption of the material is gradually increased in the future. However, indium forming ITO is a representative one of scarce and depleting resources and the supply thereof is greatly reduced. According to the specialist, it is expected that the indium is fully exhausted from about 10 to about 25 years. The indium needs to be purified using by-products of a zinc ore, which also leads to high scarcity. Even before the indium is depleted, the sudden rise in indium price leads to increase manufacturing costs of applications. Therefore, a development of a new transparent conductive layer that does not include the indium is very urgently needed.

### SUMMARY OF THE INVENTION

The present invention has been made in an effort to provide a touch panel capable of solving a depletion problem of resources used for a transparent conductive layer, in particular, improving a moiré phenomenon occurring during a image projection process when a metal electrode in a mesh shape is formed to have two layers, by replacing ITO and forming electrodes using a metal thin film on which fine patterns are formed.

According to a first preferred embodiment of the present invention, there is provided a touch panel, including: a transparent substrate; a first metal electrode formed on one surface of the transparent substrate and configured by repeatedly arranging in parallel first unit electrode lines; and a second metal electrode formed on the other surface of the transparent substrate and configured by repeatedly arranging in parallel second unit electrode lines orthogonal to the first unit electrode lines.

The first unit electrode lines may be formed in a straight line having a plurality of bent portions formed at a predetermined interval and the second unit electrode lines may be orthogonal to the first unit electrode lines and formed in a curved line having a plurality of curved portions formed at a predetermined interval.

The first unit electrode lines may be formed in a straight line having a plurality of bent portions formed at a predetermined interval and the second unit electrode lines may be orthogonal to the first unit electrode lines and formed in a straight line having a plurality of bent portions formed at a predetermined interval.

The first unit electrode lines may be formed in a curved line having a plurality of curved portions formed at a predetermined interval and the second unit electrode lines may be orthogonal to the first unit electrode lines and formed in a curved line having a plurality of curved portions formed at a predetermined interval.

The first unit electrode lines may be formed in a curved line having a plurality of curved portions formed at a predetermined interval and the second unit electrode lines may be orthogonal to the first unit electrode lines and formed in a straight line having a plurality of bent portions formed at a predetermined interval.

The touch panel may further include: a first electrode wiring formed on one surface of the transparent substrate and extending from one end of the first metal electrode and a second electrode wiring formed on the other surface of the transparent substrate and extending from one end of the second metal electrode.

According to a second preferred embodiment of the present invention, there is provided a touch panel, including: a first transparent substrate; a first metal electrode formed on one surface of the first transparent substrate and configured by repeatedly arranging in parallel first unit electrode lines; a second transparent substrate; a second metal electrode formed on one surface of the second transparent substrate and configured by repeatedly arranging in parallel second unit electrode lines orthogonal to the first unit electrode lines; and an adhesive formed between the first transparent substrate and the second transparent substrate to bond the first transparent substrate to the second transparent substrate so that the first unit electrode lines face the second unit electrode units.

The adhesive may be formed between one surface of the first transparent substrate and one surface of the second transparent substrate to bond front surfaces of the first transparent substrate and the second transparent substrate.

The adhesive may be formed between an edge of the first transparent substrate and an edge of the second transparent substrate to bond the edges of the first transparent substrate and the second transparent substrate.

The first unit electrode lines may be formed in a straight line having a plurality of bent portions formed at a predetermined interval and the second unit electrode lines may be orthogonal to the first unit electrode lines and formed in a curved line having a plurality of curved portions formed at a predetermined interval.

The first unit electrode lines may be formed in a straight line having a plurality of bent portions formed at a predetermined interval and the second unit electrode lines may be orthogonal to the first unit electrode lines and formed in a straight line having a plurality of bent portions formed at a predetermined interval.

The first unit electrode lines may be formed in a curved line having a plurality of curved portions formed at a predetermined interval and the second unit electrode lines may be orthogonal to the first unit electrode lines and formed in a curved line having a plurality of curved portions formed at a predetermined interval.

The first unit electrode lines may be formed in a curved line having a plurality of curved portions formed at a predetermined interval and the second unit electrode lines may be orthogonal to the first unit electrode lines and formed in a straight line having a plurality of bent portions formed at a predetermined interval.

The touch panel may further include: a first electrode wiring formed on one surface of the first transparent substrate and extending from one end of the first metal electrode; and a second electrode wiring formed on one surface of the second transparent substrate and extending from one end of the second metal electrode.

### BRIEF DESCRIPTION OF THE DRAWINGS

FIG. 1 is a plan view of the touch panel according to a first preferred embodiment of the present invention.

FIG. 2A is a plan view showing a first metal electrode formed on one surface of the transparent substrate configuring the touch panel of FIG. 1.

FIG. 2B is a bottom surface view showing a second metal electrode formed on the other surface of the transparent substrate configuring the touch panel of FIG. 1.

FIG. 3A is a perspective view of the touch panel according to a second preferred embodiment of the present invention.

FIG. 3B is a cross-sectional view of a touch panel according to a second preferred embodiment of the present invention.

FIG. 3C is a cross-sectional view of a touch panel according to another second preferred embodiment of the present invention.

FIG. 4 is a plan view of the touch panel according to a third preferred embodiment of the present invention.

FIG. 5A is a plan view showing a first metal electrode formed on one surface of the transparent electrode configuring the touch panel of FIG. 4.

FIG. 5B is a bottom surface view showing a second metal electrode formed on the other surface of the transparent electrode configuring the touch panel of FIG. 4.

FIG. 6 is a partially enlarged view of the first metal electrode and the second metal electrode configuring the touch panel of FIG. 4.

FIG. 7A is a plan view of a color filter substrate.

FIG. 7B is a plan view of the touch panel according to the preferred embodiment of the present invention and a color filter substrate disposed on a bottom portion of the touch panel.

FIG. 8A is a cross-sectional view of the touch panel according to the first preferred embodiment of the present invention and the color filter substrate disposed on the bottom portion of the touch panel.

FIG. 8B is a cross-sectional view of the touch panel according to the second preferred embodiment of the present invention and the color filter substrate disposed on the bottom portion of the touch panel.

FIG. 8C is a cross-sectional view of the touch panel according to another second preferred embodiment of the present invention and the color filter substrate disposed on the bottom portion of the touch panel.

### DESCRIPTION OF THE PREFERRED EMBODIMENTS

Various features and advantages of the present invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

### First Preferred Embodiment

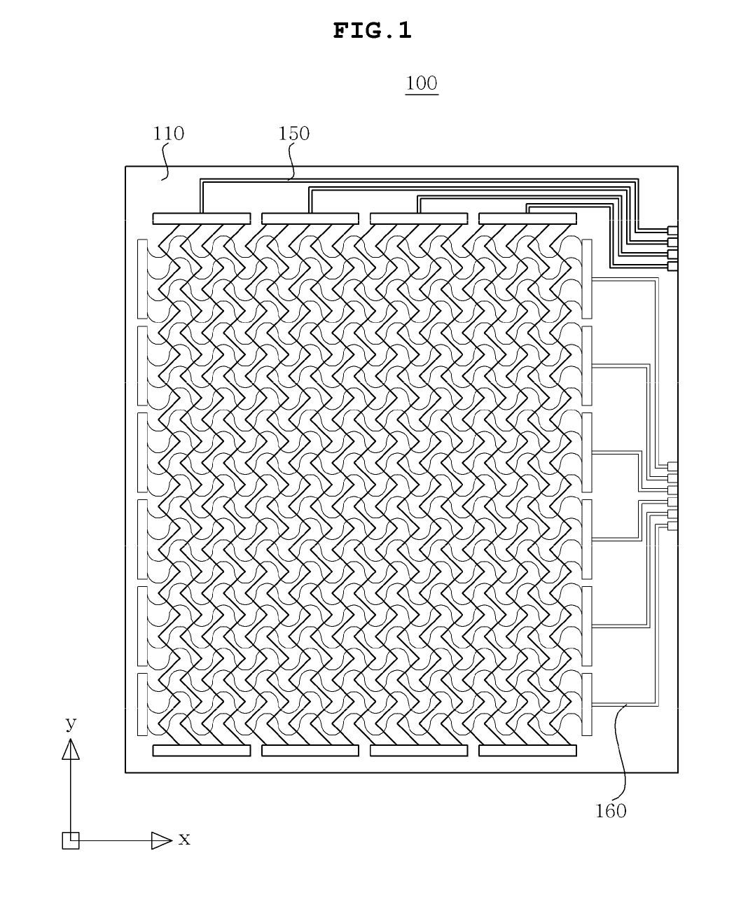

FIG. 1 is a plan view of the touch panel according to a first preferred embodiment of the present invention. As shown in FIG. 1, a touch panel 100 according to the preferred embodiment of the present invention is configured to include a transparent substrate 110 and a first metal electrode 120 and a second metal electrode 130 each formed on both surfaces of the transparent substrate 110.

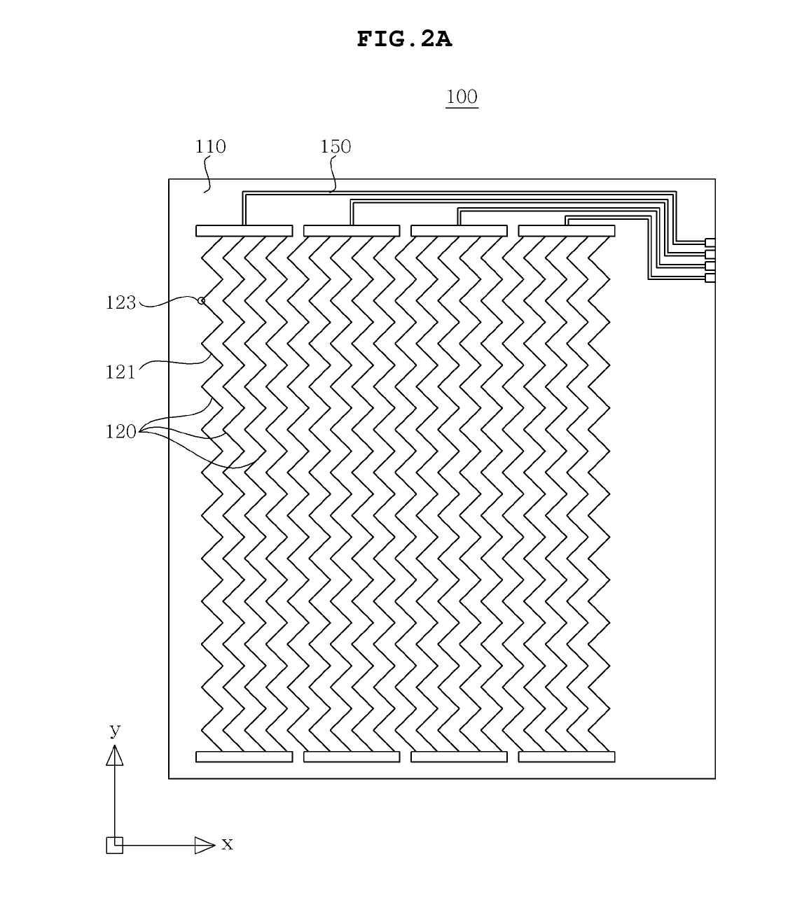

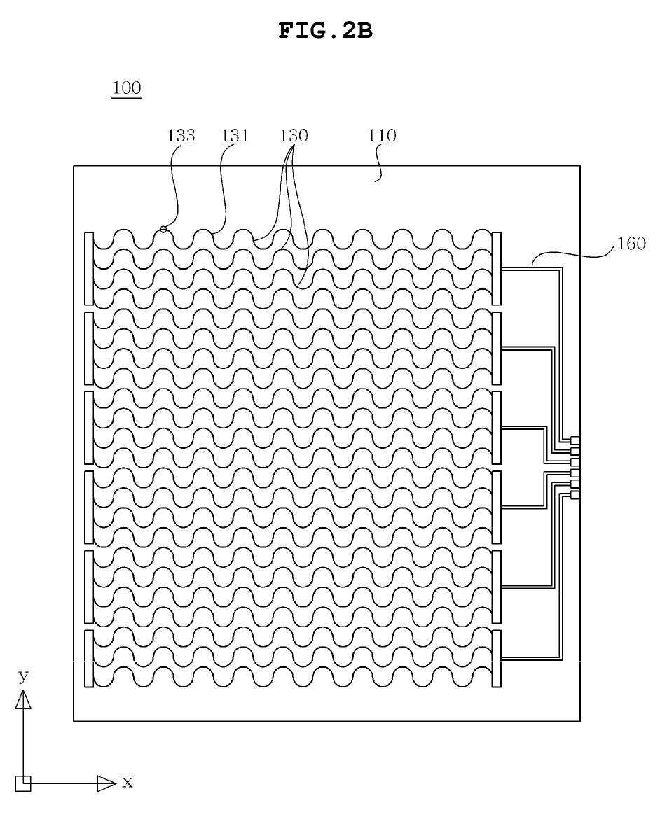

The transparent substrate 110 serves to provide a region in which the metal electrodes 120 and 130 (see FIG. 2) and electrode wirings 150 and 160 are formed. In this configuration, the transparent substrate 110 is partitioned into an active region and a bezel region, wherein the active region is a portion in which the metal electrodes 120 and 130 are formed so as to recognize a touch of an input unit and is disposed at a center of the transparent substrate 110 and the bezel region is a portion in which the electrode wirings 150 and 160 extending from the metal electrodes 120 and 130 are formed and is disposed at an edge of the active region. In this case, the transparent substrate 110 needs to have a support force capable of supporting the metal electrodes 120 and 130 and the electrode wirings 150 and 160 and transparency for a user to recognize images displayed on an image display device (not shown). When considering the above-mentioned support force and transparency, a material of the transparent substrate 110 may preferably be made of polyethylene terephthalate (PET), polycarbonate (PC), polymethylmethacrylate (PMMA), polyethylenenaphthalate (PEN), polyethersulfone (PES), cyclic olefin polymer (COC), triacetylcellulose (TAC) film, polyvinyl alcohol (PVA) film, polyimide (PI) film, polystyrene (PS), biaxially oriented polystyrene (K resin containing biaxially oriented PS) (BOPS), glass, tempered glass, or the like, but is not necessarily limited thereto.

The metal electrodes 120 and 130 (see FIG. 2) serve to allow the input unit to generate signals at the time of touch so as for a controller to recognize touched coordinates and are formed on the transparent substrate 110. In the preferred embodiment of the present invention, the metal electrodes 120 and 130 are each formed on both surfaces of the transparent substrate 110. For convenience, the metal electrode formed on one surface of the transparent substrate 100 is referred to as the first metal electrode 120 and the metal electrode formed on the other surface of the transparent substrate 110 is referred to as the second metal electrode 130. The technical features of the preferred embodiment of the present invention relate to a shape of the first metal electrode 120 and the second metal electrode 130, which will be described below. However, a selection of terms in an x-axis direction or a y-axis direction indicating an arrangement direction of unit electrode lines is provided to understand the present invention and the x-axis direction vertically intersects with the y-axis direction.

The first metal electrode 120 and the second metal electrode 130 may be formed on one surface and the other surface of the transparent substrate 110 by three combinations to be described below.

Shape 1 of Metal Electrode

The first metal electrode 120 is configured by forming a plurality of first unit electrode lines 121 on one surface of the transparent substrate 110 and repeating in parallel the plurality of first unit electrode lines 121 in a y-axis direction (see FIG. 2A). The number of first unit electrode lines 121 may be variously adopted according to a size of an active region on the transparent substrate 110 or a pitch from the first adjacent unit electrode lines 121. The first unit electrode line 121 is configured of a straight line having a plurality of bent portions 123 that are bent at a predetermined interval and is formed by extending from one end to the other end (x-axis direction) of the transparent substrate 110. That is, the first unit electrode line 121 is formed by continuing electrodes having the straight shape from one end to the other end of one surface of the transparent substrate 110, wherein the shape is similar to a zigzag pattern, a comb pattern, or a pitch pattern. The first unit electrode lines 121 are connected to each other by repeatedly arranging [an electrode having a straight shape—a bent portion 123—an electrode having a straight shape—a bent portion 123] and an interior angle formed by the adjacent electrodes having the straight shape may preferably be 90° based on the bent portion 123. Meanwhile, the bent portions 123 are formed at a predetermined interval along an extending direction (x-axis direction) of the electrodes having the straight shape and the number of straight shapes and the number of bent portions 123 may be variously adopted according to the length of the electrode having the straight shape or the size of the interior angle formed by the adjacent electrodes having the straight shape based on the bent portion 123. Commonly, however, when the first unit electrode lines 121 are configured by connecting N electrodes having the straight shape, the number of bent portions 123 is (N−1) numbers. In addition, the pitch between the first unit electrode lines 123 adjacent in the y-axis direction may be 100 μm to 800 μm and a width of the electrode having the straight shape may be 0.5 μm to 10 μm.

Meanwhile, the second metal electrode 130 is configured by forming a plurality of second unit electrode lines 131 on the other surface of the transparent substrate 110 and to repeating in parallel the plurality of second unit electrode lines 130 in the x-axis direction (see FIG. 2B). The number of second unit electrode lines 131 may be variously adopted according to the size of the active region on the transparent substrate 110 or the pitch from the second adjacent unit electrode lines 131. The second unit electrode line 131 is formed by extending the electrodes having the curved shape having a plurality of curved portions 133 that are curved at a predetermined interval from one end to the other end (y-axis direction) of the transparent substrate 110. That is, the second unit electrode line 131 is formed by continuing the electrodes having the curved shape from one end to the other end of the other surface of the transparent substrate 110, wherein the shape is similar to a wave pattern. The second unit electrode lines 131 are connected to each other by repeatedly arranging [an electrode having a curved shape—a curved portion 133—an electrode having a curved shape—a curved portion 133]. Meanwhile, the curved portion 133 is formed at a predetermined interval along an extending direction (y-axis direction) of the electrode having the curved shape and the number of electrodes and the number of curved portions 133 having the curved shape may be variously adopted according to a curvature radius of the curved line. Commonly, however, when configuring the second unit electrode lines 131 by connecting N curved lines, the number of curved portions 133 is (N−1) numbers. In addition, the pitch between the second unit electrode lines 131 adjacent in the x-axis direction may be 100 μm to 800 μm and a width of the electrode having the straight shape may be 0.5 μm to 10 μm.

In this case, the formation direction (x-axis direction) of the first unit electrode line 121 is orthogonal to the formation direction (y-axis direction) of the second unit electrode line 131 and thus, the first metal electrode 120 and the second metal electrode 130 are projected so as to vertically intersect with each other, having the transparent substrate 110 therebetween. Describing in detail the intersecting shape, portions of the electrodes having the straight shape configuring the first unit electrode lines 121 intersect with portions of the electrodes having the curved shape configuring the second unit electrode lines 131 while being spaced apart from each other by the thickness of the transparent substrate 110 and the portion on the straight line connecting two bent portions 123 adjacent to each other intersects with the portion on the curved line connecting two curved portions 133 adjacent to each other at at least one point.

Meanwhile, the metal electrodes 120 and 130 may be formed by selectively etching a metal thin film using a dry process, such as sputtering, evaporation, or the like, or a wet process such as dip coating, spin coating, roll coating, spray coating, or the like, or by using a direct patterning process, such as a screen printing method, a gravure printing method, an inkjet printing method, or the like.

Shape 2 of Metal Electrode

The first metal electrode 120 is formed on one surface of the transparent substrate 110 and the second metal electrode 130 is formed on the other surface of the transparent substrate 110 and the first metal electrode 120 and the second metal electrode 130 are projected by vertically intersecting with each other, having the transparent substrate 110 therebetween but the difference from Shape 1 of metal electrode is that the shape of the second metal electrode 130 is similar to the shape of the first metal electrode 120.

The first metal electrode 120 is configured by repeating in parallel the plurality of first unit electrode lines 121 in the y-axis direction. The number of first unit electrode lines 121 may be variously adopted according to the size of the active region on the transparent substrate 110 or the pitch from the first adjacent unit electrode lines 121.

The first unit electrode line 121 is formed by extending the electrodes having the straight shape having the plurality of bent portions 123 that are bent at a predetermined interval from one end to the other end (x-axis direction) of the transparent substrate 110. That is, the first unit electrode line 121 is formed by continuing the electrodes having the straight shape from one end to the other end of one surface of the transparent substrate 110, wherein the shape is similar to the zigzag pattern, the comb pattern, or the pitch pattern. The first unit electrode lines 121 are connected to each other by repeatedly arranging [an electrode having a straight shape—a bent portion 123—an electrode having a straight shape—a bent portion 123] and an interior angle formed by the adjacent electrodes having the straight shape may preferably be 90° based on the bent portion 123. Meanwhile, the bent portions 123 are formed at a predetermined interval along an extending direction (x-axis direction) of the electrodes having the straight shape and the number of electrodes having straight shapes and the number of bent portions 123 may be variously adopted according to the length of the electrode having the straight shape or the size of the interior angle formed by the adjacent straight lines based on the bent portion 123. Commonly, however, when the first unit electrode lines 121 are configured by connecting N electrodes having the straight shape, the number of bent portions 123 is (N−1) numbers. In addition, the pitch between the first unit electrode lines 121 adjacent in the y-axis direction may be 100 μm to 800 μm and a width of the electrode having the straight shape may be 0.5 μm to 10 μm.

Meanwhile, the second metal electrode 130 is configured by repeating in parallel the plurality of second unit electrode lines 131 in the x-axis direction. The number of second unit electrode lines 131 may be variously adopted according to the size of the active region on the transparent substrate 110 or the pitch from the second adjacent unit electrode lines 131.

The second unit electrode line 131 is formed by extending the electrodes having the straight shape having a plurality of bent portions 133 that are bent at a predetermined interval from one end to the other end (y-axis direction) of the transparent substrate 110. That is, the second unit electrode line 131 is formed by continuing the electrodes having the straight shape from one end to the other end of the other surface of the transparent substrate 110, wherein the shape has the zigzag pattern, the comb pattern, or the pitch pattern and therefore, is similar to the first unit electrode line 121. The second unit electrode lines 131 are connected to each other by repeatedly arranging [an electrode having a straight shape—a bent portion 123—an electrode having a straight shape—a bent portion 123]. Meanwhile, the bent portions 123 are formed at a predetermined interval along an extending direction (y-axis direction) of the straight electrodes and the number of straight shapes and the number of bent portions 123 may be variously adopted according to the length of the electrode having the straight shape or the size of the interior angle formed by the adjacent straight lines based on the bent portion 123. Commonly, however, when the second unit electrode lines are configured by connecting N electrodes having the straight shape, the number of bent portions 123 is (N−1) numbers. In addition, the pitch between the second unit electrode lines 131 adjacent in the x-axis direction may be 100 μm to 800 μm and a width of the electrode having the straight shape may be 0.5 μm to 10 μm.

In this case, the formation direction (x-axis direction) of the first unit electrode line 121 is orthogonal to the formation direction (y-axis direction) of the second unit electrode line 131 and thus, the first metal electrode 120 and the second metal electrode 130 are projected so as to vertically intersect with each other, having the transparent substrate 110 therebetween. Describing in detail the intersecting shape, portions of the straight line configuring the first unit electrode lines 121 intersect with portions of the straight line configuring the second unit electrode lines 131 intersect with each other while being spaced apart from each other by the thickness of the transparent substrate 110 and the portion on the straight line connecting two bent portions adjacent to each other intersects with the portion on the straight line connecting two bent portions adjacent to each other at at least one point.

Meanwhile, the method for forming the metal electrodes 120 and 130 is the same as the first preferred embodiment and the repeated description thereof will be omitted.

Shape 3 of Metal Electrode

The first metal electrode 120 is formed on one surface of the transparent substrate 110 and the second metal electrode 130 is formed on the other surface of the transparent substrate 110 and the first metal electrode 120 and the second metal electrode 130 vertically intersect with each other, having the transparent substrate 110 therebetween but the difference from Shape 2 of metal electrode is that the shape of the first metal electrode 120 and the shape of the second metal electrode 130 are configured by the electrodes having the curved shape.

The first metal electrode 120 is configured by repeating in parallel the plurality of first unit electrode lines 121 in the y-axis direction. The number of first unit electrode lines 121 may be variously adopted according to the size of the active region on the transparent substrate 110 or the pitch from the first adjacent unit electrode lines 121.

The first unit electrode line 121 is formed by extending the electrodes having the curved shape having the plurality of curved portions 133 that are curved at a predetermined interval from one end to the other end (x-axis direction) of the transparent substrate 110. That is, the first unit electrode line 121 is formed by continuing the electrodes having the curved shape from one end to the other end of one surface of the transparent substrate 110, wherein the shape is similar to a wave pattern. The first unit electrode lines 121 are connected to each other by repeatedly arranging [an electrode having curved shape—a curved portion 133—an electrode having curved shape—a curved portion 133]. Meanwhile, the curved portion 133 is formed at a predetermined interval along an extending direction (x-axis direction) of the curved electrode and the number of electrodes having the curved shape and the number of curved portions 133 may be variously adopted according to the curvature radius of the curved line. Commonly, however, when configuring the first unit electrode lines 121 by connecting N curved lines, the number of curved portions 133 is (N−1) numbers. In addition, the pitch between the first unit electrode lines 123 adjacent in the y-axis direction may be 100 μm to 800 and a width of the electrode having the straight shape may be 0.5 μm to 10 μm.

Meanwhile, the second metal electrode 130 is configured by repeating in parallel the plurality of second unit electrode lines 131 in the x-axis direction. The number of second unit electrode lines 131 may be variously adopted according to the size of the active region on the transparent substrate 110 or the pitch from the second adjacent unit electrode lines 131.

The second unit electrode line 131 is formed by extending the electrodes having the curved shape having the plurality of curved portions 133 that are curved at a predetermined interval from one end to the other end (y-axis direction) of the transparent substrate 110. That is, the second unit electrode line 131 is formed by continuing the electrodes having the curved shape from one end to the other end of the other surface of the transparent substrate 110, wherein the shape is similar to the wave pattern. The second unit electrode lines 131 are connected to each other by repeatedly arranging [an electrode having curved shape—a curved portion 133—an electrode having curved shape—a curved portion 133]. Meanwhile, the curved portion 133 is formed at a predetermined interval along an extending direction (y-axis direction) of the electrode having the curved shape and the number of electrodes having the curved shape and the number of curved portions 133 may be variously adopted according to the curvature radius of the curved line. Commonly, however, when configuring the second unit electrode lines 131 by connecting the electrodes having N curved lines, the number of curved portions 133 is (N−1) numbers. In addition, the pitch between the second unit electrode lines 131 adjacent in then x-axis direction may be 100 μm to 800 μm and the width of the electrode having the straight shape may be 0.5 μm to 10 μm.

In this case, the formation direction (x-axis direction) of the first unit electrode line 121 is orthogonal to the formation direction (y-axis direction) of the second unit electrode line 131 and thus, the first metal electrode 120 and the second metal electrode 130 are projected so as to vertically intersect with each other, having the transparent substrate 110 therebetween. Describing in detail the intersecting shape, portions of the electrodes having the curved shape configuring the first unit electrode lines 121 intersect with portions of the electrodes having the curved shape configuring the second unit electrode lines 131 while being spaced apart from each other by the thickness of the transparent substrate 110 and a portion on the electrode having the curved shape connecting two curved portions 133 adjacent to each other intersects with a portion on the electrode having the curved line connecting two curved portions 133 adjacent to each other at least one point. The method for forming the metal electrodes 120 and 130 is the same as the first and second preferred embodiments and the repeated description thereof will be omitted.

Meanwhile, in the touch panel of the preferred embodiment of the present invention, the electrode wirings 150 and 160 receiving electrical signals from the first metal electrode 120 and the second electrode 130 are formed in the edges of the first metal electrode 120 and the second metal electrode 130 formed on the transparent substrate 110, that is, the bezel region of the transparent substrate 110 The electrode wirings 150 and 160 may be printed using the screen printing method, the gravure printing, the inkjet printing method, or the like, in particular, the preferred embodiment of the present invention may simultaneously print the metal electrodes 120 and 130 and the electrode wirings 150 and 160. In addition, as the materials for the electrode wirings 150 and 160, materials composed of silver paste (Ag paste) or organic silver having excellent electric conductivity may be used. However, the preferred embodiment of the present invention is not limited thereto and therefore, a conductive polymer or low-resistant metal of metal oxides or metals such as carbon black (including CNT), ITO, or the like, may be used. As shown in FIG. 2, the first electrode wiring 150 is formed so as to extend from one end or the other end of the first metal electrode 120 (FIG. 2A) and the second electrode wiring 160 is formed so as to extend from one end or the other end of the second metal electrode 130 (FIG. 2B). In detail, at least two first unit electrode lines 121 are formed in one set and the first electrode wiring 150 extends from one end or the other end of each set so as to be extendedly formed to the bezel region on one surface of the transparent substrate 110. Further, at least two second unit electrode lines 131 are formed in one set and the second electrode wiring 160 extends from one end or the other end of each set so as to be formed in the bezel region on the other surface of the transparent substrate 110.

Shape 4 of Metal Electrode

The first metal electrode 120 is formed on one surface of the transparent substrate 110 and the second metal electrode 130 is formed on the other surface of the transparent substrate 110 and the first metal electrode 120 and the second metal electrode 130 vertically intersects with each other, having the transparent substrate 110 therebetween but the difference from Shape 3 of metal electrode is that the shape of the first metal electrode 120 and the shape of the second metal electrode 130 are formed in the curved shape and the straight shape.

The first metal electrode 120 is configured by repeating in parallel the plurality of first unit electrode lines 121 in the y-axis direction. The number of first unit electrode lines 121 may be variously adopted according to the size of the active region on the transparent substrate or the pitch from the first adjacent unit electrode lines 121.

The first unit electrode line 121 is formed by extending the electrodes having the curved shape having the plurality of curved portions 133 that are curved at a predetermined interval from one end to the other end (x-axis direction) of the transparent substrate 110. That is, the first unit electrode line 121 is formed by continuing the electrodes having the curved shape from one end to the other end of one surface of the transparent substrate 110, wherein the shape is similar to the wave pattern. The first unit electrode lines 121 are connected to each other by repeatedly arranging [an electrode having curved shape—a curved portion 133—an electrode having curved shape—a curved portion 133]. Meanwhile, the curved portion 133 is formed at a predetermined interval along the extending direction (x-axis direction) of the curved electrode and the number of electrodes and the number of curved portions 133 having the curved shape may be variously adopted according to the curvature radius of the curved line. Commonly, however, when configuring the first unit electrode lines 121 by connecting N curved lines, the number of curved portions 133 is (N−1) numbers. In addition, the pitch between the first unit electrode lines 121 adjacent in the y-axis direction may be 100 μm to 800 μm and a width of the electrode having the straight shape may be 0.5 μm to 10 μm.

Meanwhile, the second metal electrode 130 is configured by repeating in parallel the plurality of second unit electrode lines 131 in the x-axis direction. The number of second unit electrode lines 131 may be variously adopted according to the size of the active region on the transparent substrate 110 or the pitch from the second adjacent unit electrode lines 131.

The second unit electrode line 131 is formed by extending the electrodes having the straight shape having the plurality of bent portions 123 that are bent at a predetermined interval from one end to the other end (y-axis direction) of the transparent substrate 110. That is, the second unit electrode line 131 is formed by continuing the electrodes having the straight shape from one end to the other end of the other surface of the transparent substrate 110, wherein the shape is similar to the zigzag pattern, the comb pattern, or the pitch pattern. The second unit electrode lines 131 are connected to each other by repeatedly arranging [an electrode having straight shape—a bent portion 123—an electrode having straight shape—a bent portion 123]. Meanwhile, the bent portions 123 are formed at a predetermined interval along an extending direction (x-axis direction) of the straight electrodes and the number of electrodes having a straight shape and the number of bent portions 123 may be variously adopted according to the length of the electrode having the straight shape or the size of the interior angle formed by the adjacent straight lines based on the bent portion 123. Commonly, however, when the second unit electrode lines are configured by connecting N electrodes having the straight shape, the number of bent portions 123 is (N−1) numbers. In addition, the pitch between the second unit electrode lines 131 adjacent in the x-axis direction may be 100 μm to 800 μm and a width of the electrode having the straight shape may be 0.5 μm to 10 μm.

In this case, the formation direction (x-axis direction) of the first unit electrode line 121 is orthogonal to the formation direction (y-axis direction) of the second unit electrode line 131 and thus, the first metal electrode 120 and the second metal electrode 130 are projected so as to vertically intersect with each other, having the transparent substrate 110 therebetween. Describing in detail the intersecting shape, the portions of the electrodes having the curved shape configuring the first unit electrode lines 121 intersect with the portions of the electrodes having the straight shape configuring the second unit electrode lines 131 while being spaced apart from each other by the thickness of the transparent substrate 110 and the portion on the straight line connecting two bent portions 123 adjacent to each other intersects with the portion on the curved line connecting two curved portions 133 adjacent to each other at at least one point. The method for forming the metal electrodes 120 and 130 is the same as the first, second, and third preferred embodiments and the repeated description thereof will be omitted.

Meanwhile, in the touch panel of the exemplary embodiment of the present invention, the electrode wirings 150 and 160 receiving electrical signals from the first metal electrode 120 and the second electrode 130 are formed in the edges of the first metal electrode 120 and the second metal electrode 130 formed on the transparent substrate 110, that is, the bezel region of the transparent substrate 110. The electrode wirings 150 and 160 may be printed using the screen printing method, the gravure printing method, the inkjet printing method, or the like, in particular, the exemplary embodiment of the present invention may simultaneously print the metal electrodes 120 and 130 and the electrode wirings 150 and 160. In addition, as the materials for the electrode wirings 150 and 160, materials composed of silver paste (Ag paste) or organic silver having excellent electric conductivity may be used. However, the exemplary embodiment of the present invention is not limited thereto and therefore, a conductive polymer or low-resistance metal of metal oxides or metals such as carbon black (including CNT), ITO, or the like, may be used. As shown in FIG. 2, the first electrode wiring 150 is formed so as to extend from one end or the other end of the first metal electrode 120 (FIG. 2A) and the second electrode wiring 160 is formed so as to extend from one end or the other end of the second metal electrode 130 (FIG. 2B). In detail, at least two first unit electrode lines 121 are formed in one set and the first electrode wiring 150 extends from one end or the other end of each set so as to be extendedly formed to the bezel region on one surface of the transparent substrate 110. Further, at least two second unit electrode lines 131 are formed in one set and the second electrode wiring 160 extends from one end or the other end of each set so as to be formed in the bezel region on the other surface of the transparent substrate 110.

### Second Preferred Embodiment

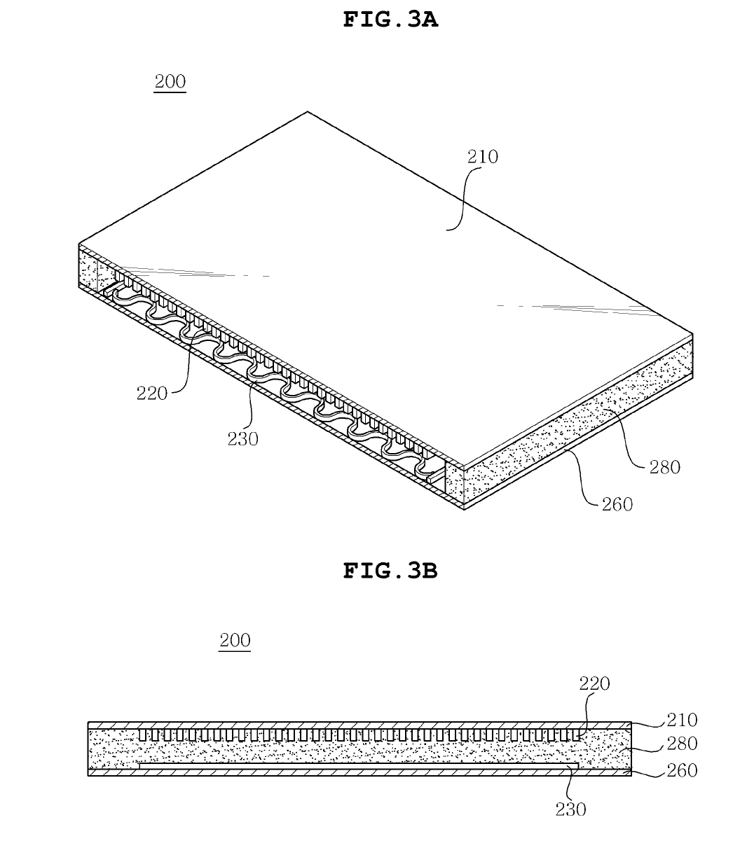

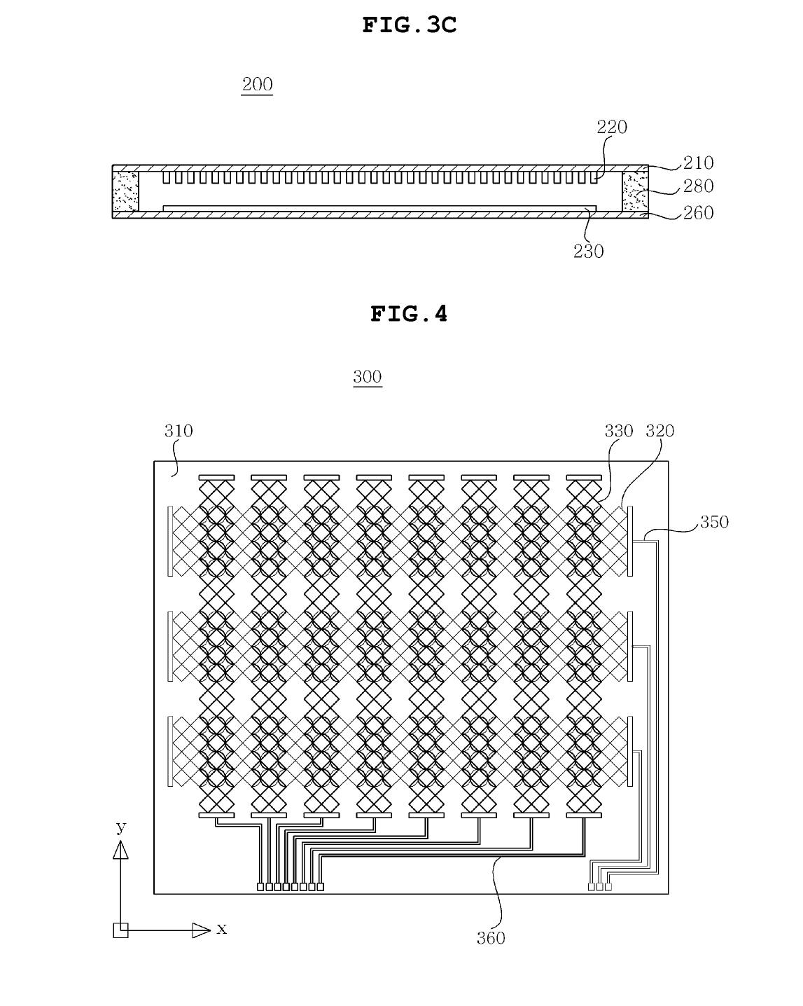

Meanwhile, FIG. 3A is a perspective view of a touch panel according to a second preferred embodiment of the present invention and FIG. 3B is a cross-sectional view of the touch panel according to the preferred embodiment of the present invention. As shown in FIG. 3B, the touch panel according to the second preferred embodiment of the present invention may be formed by bonding front surfaces of a pair of transparent substrates 210 and 260 having metal electrodes 220 and 230 formed on surfaces thereof by an adhesive 280. That is, the first metal electrode 220 is formed on one surface of the first transparent substrate 210 and the second metal electrode 230 is formed on one surface of the second transparent substrate 260 and the adhesive 280 is generally formed between one surface of the first transparent substrate 210 and one surface of the second transparent substrate 260 to bond the front surfaces of both transparent substrates, thereby forming the touch panel 200. The adhesive 280 serves to bond the first transparent substrate 210 to the second transparent substrate 260 so that the first metal electrode 220 and the second metal electrode 230 are disposed to face each other. In this configuration, the material of the adhesive 280 is not particularly limited thereto, but an optical clear adhesive (OCA) may preferably be used.

Meanwhile, the first metal electrode 220 is configured by repeating the first unit electrode lines in parallel, the second metal electrode 230 is configured by repeatedly arranging the second unit electrode lines in parallel, and the first unit electrode line and the second unit electrode line are projected so as to be orthogonal to each other. In addition, the first electrode wiring (not shown) is further formed on one surface of the first transparent substrate 210 so as to extend from one end of the first metal electrode 220 and the second electrode wiring (not shown) is further formed on one surface of the second transparent substrate 26Q so as to extend from one end of the second metal electrode 230.

The detailed description of the transparent substrate (first transparent substrate 210 and second transparent substrate 260), the metal electrodes 220 and 230, and the electrode wirings (not shown) is the same as one described in the first preferred embodiment and the repeated description thereof will be omitted.

FIG. 3C is a cross-sectional view of a touch panel according to another second preferred embodiment of the present invention. As shown in FIG. 3C, the touch panel 200 according to the preferred embodiment of the present invention may be formed by bonding a pair of transparent substrates 210, 260 having the metal electrodes 220 and 230 formed on surfaces thereof, respectively, by the adhesive 280. That is, the first metal electrode 220 is formed on one surface of the first transparent substrate 210, the second metal electrode 230 is formed on one surface of the second transparent substrate 260, and the adhesive 280 is formed between edges of the first transparent substrate 210 and the second transparent substrate 260 to bond both transparent substrates, thereby forming the touch panel 200. Herein, the adhesive 280 serves to bond the edge of the first transparent substrate 210 to the edge of the second transparent substrate 260 so that the first metal electrode 200 and the second metal electrode 230 are disposed to face each other. In this configuration, the material of the adhesive 280 is not particularly limited thereto, but the optical clear adhesive (OCA) or a double adhesive tape (DAT) may preferably be used.

Meanwhile, the first metal electrode 220 is configured by repeating the first unit electrode lines in parallel, the second metal electrode 230 is configured by repeatedly arranging the second unit electrode lines in parallel, and the first unit electrode line and the second unit electrode line are projected so as to be orthogonal to each other. In addition, the first electrode wiring (not shown) is further formed on one surface of the first transparent substrate 210 so as to extend from one end of the first metal electrode 220 and the second electrode wiring (not shown) is further formed on one surface of the second transparent substrate 260 so as to extend from one end of the second metal electrode 230.

The detailed description of the transparent substrate (first transparent substrate 210 and second transparent substrate 260), the metal electrodes 220 and 230, and the electrode wirings (not shown) is the same as one described in the first preferred embodiment and the repeated description thereof will be omitted.

### Third Preferred Embodiment

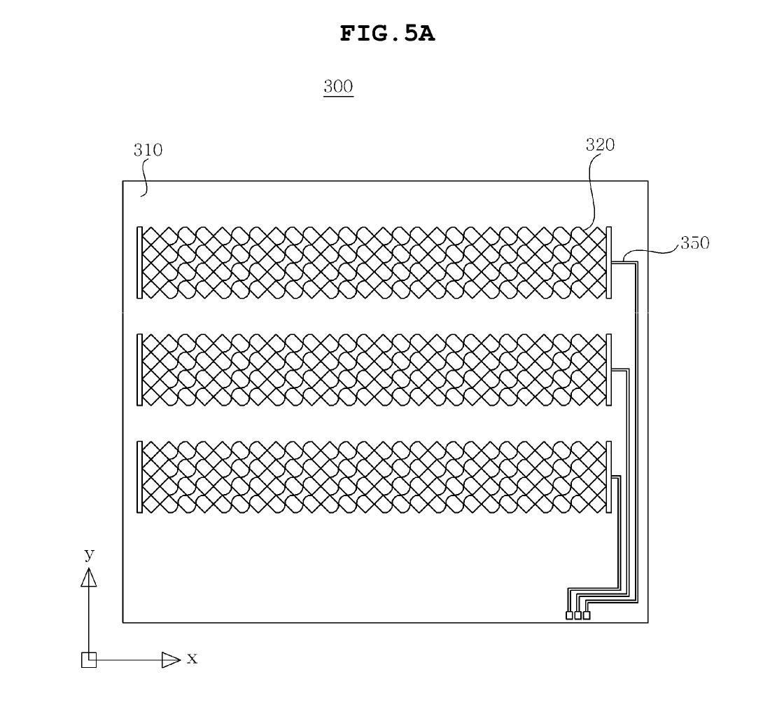

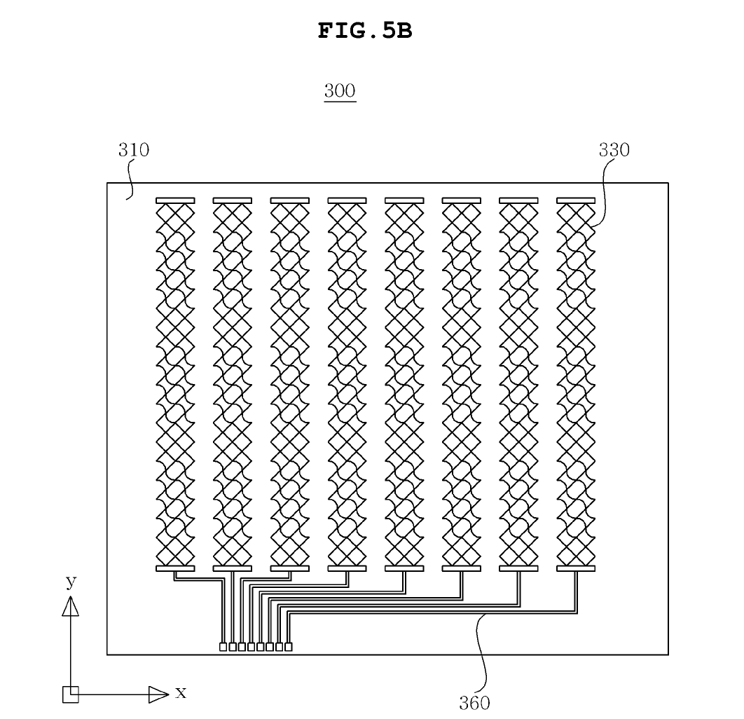

FIGS. 4 and 5 are plan views of a touch panel according to a third preferred embodiment of the present invention. A first metal electrode 320 is formed on one surface of a transparent substrate 310 (see FIG. 5A) and a second metal electrode 330 is formed on the other surface of the transparent substrate 310(see FIG. 5B). In addition, a first electrode wiring 350 is formed on one surface of the transparent substrate 310 so as to extend from one end of the first metal electrode 320 and a second electrode wiring 360 is formed on the other surface of the transparent substrate 310 so as to extend from one end of the second metal electrode 330.

The detailed description of the transparent substrate 31Q and the electrode wirings 350 and 360 is the same as one described in the first preferred embodiment and the repeated description thereof will be omitted. Hereinafter, the shape of the first metal electrode 320 and the second metal electrode 330 will be described in detail.

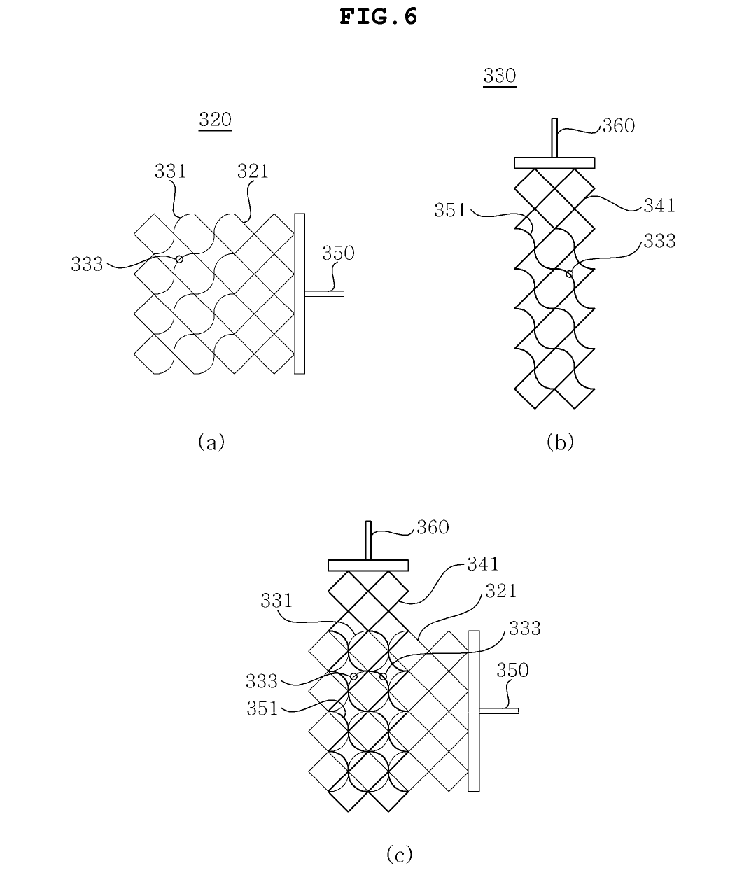

FIG. 6 is a partially enlarged view of the first metal electrode and the second metal electrode configuring the touch panel of FIG. 4. The first metal electrode 320 is formed on one surface of the transparent substrate 310 and the first unit electrode line 321 and the second unit electrode line 331 are configured so as to be orthogonal to each other (see FIG. 6A). The first unit electrode line 321 is configured by the plurality of electrodes having the straight shape repeatedly arranged in parallel in one direction and the second unit electrode line 331 vertically intersects with the first unit electrode line 321 and the electrodes having the curved shape having the plurality of curved portions 333 formed at a predetermined interval are configured to be repeatedly arranged in parallel.

Meanwhile, the second metal electrode 330 is formed on the other surface of the transparent substrate 310 and the third unit electrode line 341 and the fourth unit electrode line 351 are configured so as to be orthogonal to each other (see FIG. 6B). The third unit electrode line 341 is configured by repeatedly arranging in parallel the electrodes having the straight shape orthogonal to the first unit electrode line 321 and the fourth unit electrode line 351 is orthogonal to the second unit electrode line 331 and configured by repeatedly arranging in parallel the electrodes having the curved shape having the plurality of curved portions 333 formed at a predetermined interval.

The shape in which the first metal electrode 320 intersects with the second metal electrode 330 is shown in FIG. 6C. That is, the first unit electrode line 321 of the first metal electrode 320 and the fourth unit electrode line 351 of the second metal electrode 330 are disposed to minimize overlapping lines and the second unit electrode line 331 of the first metal electrode 320 and the third unit electrode line 341 of the second metal electrode 330 are also disposed to minimize overlapping lines.

As described in the first preferred embodiment, the second preferred embodiment, and the third preferred embodiment, the first metal electrode or the second metal electrode, which are combined to have the shape in which the electrode having the straight shape having the plurality of bending parts extends or the shape in which the electrode having the curved shape having the plurality of curved portions extends, are each disposed on both surfaces of the transparent substrate, such that the moiré phenomenon may be reduced in the following two aspects.

First, the moiré phenomenon may be reduced by the inherent interference between the first metal electrode and the second metal electrode. That is, the first metal electrode is formed by arranging the plurality of first unit electrode lines on one surface of the transparent substrate so as to be parallel in one direction and the plurality of second unit electrode lines are arranged on the other surface of the transparent substrate so as to be parallel in a direction vertical to the arrangement direction of the first unit electrode lines to form the second metal electrode, thereby minimizing overlapping lines of the first unit electrode line and the second unit electrode line. As a result, the deterioration in image quality due to the interference fringe occurring when two lines parallel with each other overlaps each other may be improved.

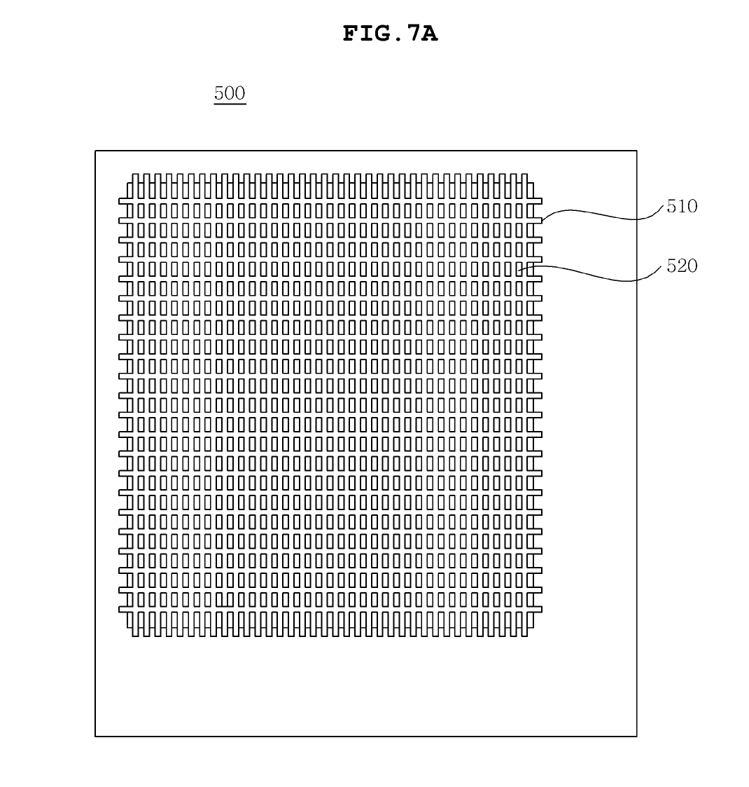

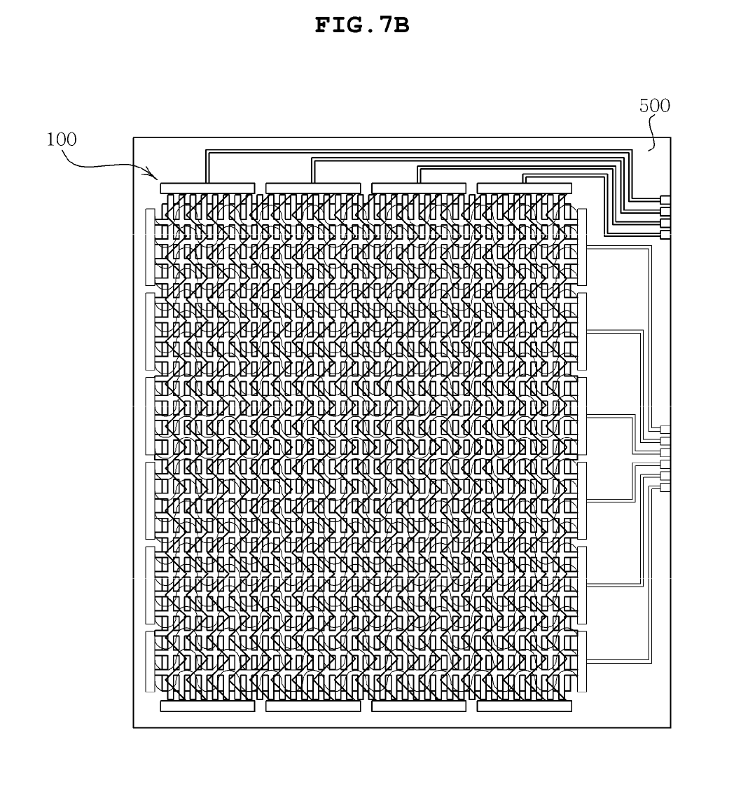

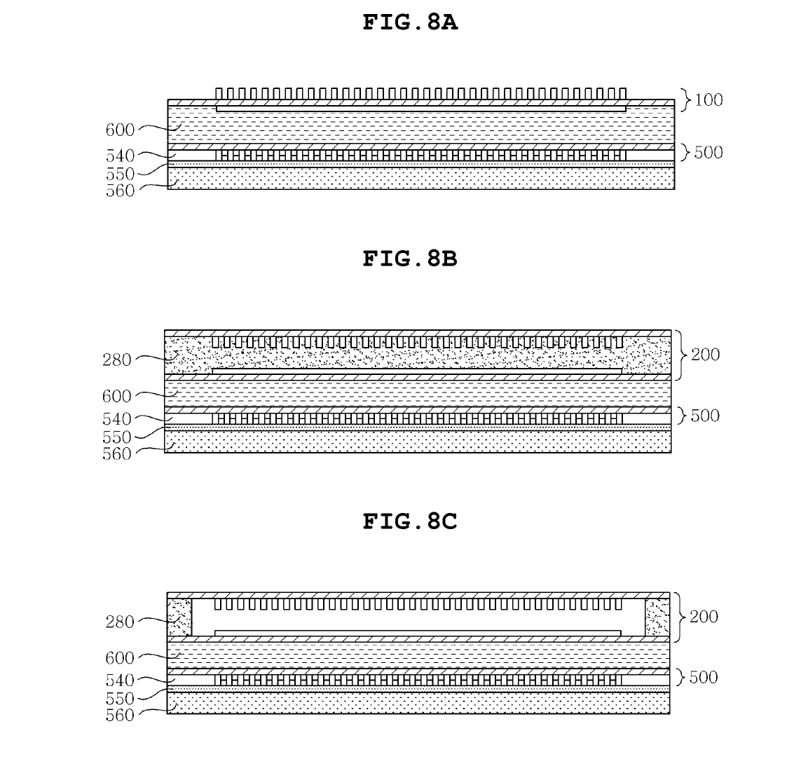

Next, visibility may be improved by minimizing overlapping lines between the first metal electrode and the second metal electrode and a pixel grid 520 or a black matrix 510 formed on a color filter substrate 500. FIG. 7A is a plan view of a color filter substrate, FIG. 7B shows the touch panel according to the preferred embodiment of the present invention and a color filter substrate disposed on a bottom portion of the touch panel, FIG. 8A shows the touch panel according to the first preferred embodiment of the present invention and the color filter substrate disposed on the bottom portion of the touch panel, FIG. 8B shows the touch panel according to the second preferred embodiment of the present invention and the color filter substrate disposed on the bottom portion of the touch panel, and FIG. 8C shows the touch panel according to another second preferred embodiment of the present invention and the color filter substrate disposed on the bottom portion of the touch panel.

Referring to FIG. 7A, the pixels of red, green, and blue colors are regularly arranged on the color filter substrate 500 in a lattice form and the black matrix 510 is formed between each pixel grid 520 in a mesh pattern. As shown in FIG. 7B, when the color filter substrate 500 is further formed on the touch panels 100 and 200 according to the exemplary embodiment of the present invention, the moiré phenomenon may occur between the metal electrode formed on the touch panels 100 and 200 and the black matrix 510 formed on the color filter substrate 500 due to overlapping lines. The metal electrode is formed on the transparent substrate by regularly arranging the electrodes having the fine line width and the black matrix 510 is formed between the pixel grid to have a dense net shape. In the exemplary embodiments of the present invention, the first metal electrode and the second metal electrode are formed in the zigzag pattern or the wave pattern and thus, are out of the predetermined angle or more from the net shape of the pixel grid 520 or the black matrix 510, thereby minimizing the overlapping lines between both configurations. Therefore, the deterioration in image quality due to the interference fringe occurring when the regularly distributed lines overlap each other can be improved.

As set forth above, the preferred embodiments of the present invention can improve the moiré phenomenon occurring due to overlapping lines between the top and bottom metal electrodes on the transparent substrate during the image projection process.

In addition, the preferred embodiments of the present invention can improve the visibility by minimizing overlapping lines between the metal electrode formed on the transparent substrate and the pixel grid or the black matrix formed on the color filter.

Although the embodiment of the present invention has been disclosed for illustrative purposes, it will be appreciated that a touch panel according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
a first metal electrode formed on one surface of the transparent substrate and configured by repeatedly arranging in parallel first unit electrode lines; and
a second metal electrode formed on the other surface of the transparent substrate and configured by repeatedly arranging in parallel second unit electrode lines orthogonal to the first unit electrode lines.

2. The touch panel as set forth in claim 1, wherein the first unit electrode lines are formed in a straight line having a plurality of bent portions formed at a predetermined interval, and
the second unit electrode lines are orthogonal to the first unit electrode lines and formed in a curved line having a plurality of curved portions formed at a predetermined interval.

3. The touch panel as set forth in claim 1, wherein the first unit electrode lines are formed in a straight line having a plurality of bent portions formed at a predetermined interval, and
the second unit electrode lines are orthogonal to the first unit electrode lines and formed in a straight line having a plurality of bent portions formed at a predetermined interval.

4. The touch panel as set forth in claim 1, wherein the first unit electrode lines are formed in a curved line having a plurality of curved portions formed at a predetermined interval, and
the second unit electrode lines are orthogonal to the first unit electrode lines and formed in a curved line having a plurality of curved portions formed at a predetermined interval.

5. The touch panel as set forth in claim 1, wherein the first unit electrode lines are formed in a curved line having a plurality of curved portions formed at a predetermined interval, and
the second unit electrode lines are orthogonal to the first unit electrode lines and formed in a straight line having a plurality of bent portions formed at a predetermined interval.

6. The touch panel as set forth in claim 1, further comprising:
a first electrode wiring formed on one surface of the transparent substrate and extending from one end of the first metal electrode; and
a second electrode wiring formed on the other surface of the transparent substrate and extending from one end of the second metal electrode.

7. A touch panel, comprising:
a first transparent substrate;
a first metal electrode formed on one surface of the first transparent substrate and configured by repeatedly arranging in parallel first unit electrode lines;
a second transparent substrate;
a second metal electrode formed on one surface of the second transparent substrate and configured by repeatedly arranging in parallel second unit electrode lines orthogonal to the first unit electrode lines; and
an adhesive formed between the first transparent substrate and the second transparent substrate to bond the first transparent substrate to the second transparent substrate so that the first unit electrode lines face the second unit electrode units.

8. The touch panel as set forth in claim 7, wherein the adhesive is formed between one surface of the first transparent substrate and one surface of the second transparent substrate to bond front surfaces of the first transparent substrate and the second transparent substrate.

9. The touch panel as set forth in claim 7, wherein the adhesive is formed between an edge of the first transparent substrate and an edge of the second transparent substrate to bond the edges of the first transparent substrate and the second transparent substrate.

10. The touch panel as set forth in claim 7, wherein the first unit electrode lines are formed in a straight line having a plurality of bent portions formed at a predetermined interval, and
the second unit electrode lines are orthogonal to the first unit electrode lines and formed in a curved line having a plurality of curved portions formed at a predetermined interval.

11. The touch panel as set forth in claim 7, wherein the first unit electrode lines are formed in a straight line having a plurality of bent portions formed at a predetermined interval, and
the second unit electrode lines are orthogonal to the first unit electrode lines and formed in a straight line having a plurality of bent portions formed at a predetermined interval.

12. The touch panel as set forth in claim 7, wherein the first unit electrode lines are formed in a curved line having a plurality of curved portions formed at a predetermined interval, and
the second unit electrode lines are orthogonal to the first unit electrode lines and formed in a curved line having a plurality of curved portions formed at a predetermined interval.

13. The touch panel as set forth in claim 7, wherein the first unit electrode lines are formed in a curved line having a plurality of curved portions formed at a predetermined interval, and
the second unit electrode lines are orthogonal to the first unit electrode lines and formed in a straight line having a plurality of bent portions formed at a predetermined interval.

14. The touch panel as set forth in claim 7, further comprising:
a first electrode wiring formed on one surface of the first transparent substrate and extending from one end of the first metal electrode; and
a second electrode wiring formed on one surface of the second transparent substrate and extending from one end of the second metal electrode.
